(19) United States
(12) Patent Application Publication
(10) Pub. No.: US 2018/0136368 A1
(43) Pub. Date: May 17, 2018

(54) Antireflective Surface Structures on Optical Elements

(71) Applicant: The Government of the United States of America, as represented by the Secretary of the Navy, Arlington, VA (US)

(72) Inventors: Jesse A. Frantz, Washington, DC (US); Lynda E. Busse, Alexandria, VA (US); L. Brandon Shaw, Woodbridge, VA (US); Jasbinder S. Sanghera, Ashburn, VA (US); Ishwar D. Aggarwal, Waxhaw, NC (US); Kevin J. Major, Charlotte, NC (US); Menelaos K. Poutous, Harrisburg, NC (US); Karteek Kunala, Charlotte, NC (US)

(73) Assignee: The Government of the United States of America, as represented by the Secretary of the Navy, Arlington, VA (US)

(21) Appl. No.: 15/812,660

(22) Filed: Nov. 14, 2017

Related U.S. Application Data
(60) Provisional application No. 62/421,710, filed on Nov. 14, 2016.

(51) Int. Cl. G02B 1/113; C03C 17/34; C03C 25/68; H05H 1/46; H01S 1/06; G02B 6/26; B05D 5/06

(52) U.S. Cl. CPC G02B 1/113; C03C 17/3417; C03C 25/68; B05D 5/06; H01S 1/06; G02B 6/262; H05H 1/46

(57) ABSTRACT

The invention relates to methods for fabricating antireflective surface structures (ARSS) on optical elements. Optical elements having ARSS on at least one surface are also provided.

### CROSS-REFERENCE TO RELATED APPLICATIONS

This application claims priority to U.S. Provisional Application No. 62/421,710, filed on Nov. 14, 2016, the contents of which are incorporated herein by reference in their entirety.

### TECHNICAL FIELD

This application relates generally to methods for fabricating antireflective surface structures (ARSS) on optical elements. Optical elements having ARSS on at least one surface are also provided.

### BACKGROUND OF THE INVENTION

ZnS is an optical material with a broad transparency window from approximately 0.4-12 μm. See II-VI: World's Leading Producer of Optical Materials (2015), Vol. MA15. It has found a variety of applications. It is often the material of choice for defense-related applications in the 8-12 μm wavelength range, due to its high transmission at these wavelengths. See II-VI: World's Leading Producer of Optical Materials (2015), Vol. MA15; C. Hu, et al., “Effects of the chemical bonding on the optical and mechanical properties for germanium carbide films used as antireflection and protection coating of ZnS windows,” J. Phys. Condens. Matter 18, 4231-4241 (2006); and C. A. Klein, et al., “ZnS, ZnSe, and ZnS/ZnSe windows: their impact on FLIR system performance,” Opt Eng. 25, 254519-254519 (1986). ZnS is also used in applications in which a window must transmit across a broad spectral range.

One challenge in using ZnS for optical components arises from its relatively high refractive index. ZnS exhibits a refractive index considerably higher than many common optical materials, such as silicate glasses. For example, at a wavelength of 12 μm, its refractive index is 2.22, resulting in a Fresnel reflection of over 14% from one surface at normal incidence. This value is considerably larger than that for a single surface of a silicate glass, which is approximately 4% at wavelengths for which it is transparent. In many optical systems, Fresnel reflections from an optical surface have a variety of undesirable effects. These include reduced transmittance; feedback into laser systems; stray reflections; and, in the case of military applications, potential detection by enemy combatants.

In bulk optics, Fresnel reflections are traditionally reduced using thin film dielectric stacks of materials with alternating high and low refractive indices. Thin film interference effects in these stacks can lead to antireflective (AR) properties for a range of wavelengths and angles. Dielectric AR coatings have previously been applied to ZnS optics. See X. Su, et al., “Design and fabrication of antireflection coatings on ZnS substrate,” in SPIE Proc. v. 6149, 2nd International Symposium on Advanced Optical Manufacturing and Testing Technologies: Advanced Optical Manufacturing Technologies, L. Yang, et al., eds. (2006), p. 614907. Such coatings, however, have several problems associated with them. They exhibit laser-induced damage thresholds (LIDTs) significantly lower than those of the bulk optics; are subject to environmental degradations and delamination under thermal cycling; and perform well only for a limited optical bandwidth and angular range. The latter issue is especially pertinent to ZnS because one of the principal reasons that it is of interest is because of its broad transmittance range.

One approach that has proven effective in reducing Fresnel reflections while reducing the problems associated with traditional AR coatings is the direct nano-patterning of ARSSs on the surface of optics. See L. E. Busse, et al., “Anti-reflective surface structures for spinet ceramics and fused silica windows, lenses and optical fibers,” Opt. Mater. Express 4, 2504-2515 (2014); L. E. Busse, et al., “Review of antireflective surface structures on laser optics and windows,” Appl. Opt. 54, F303 (2015); and U.S. Pat. No. 8,187,481. Processing of these structures does not involve a permanent coating on the optic, but instead relies on nano-patterning of the surface of the optical material itself. State-of-the-art processing has resulted in antireflective performance of ARSS comparable to that of the traditional AR coatings, while adding significant advantages such as higher laser damage thresholds (D. S. Hobbs, et al., “Laser damage resistant anti-reflection microstructures in Raytheon ceramic YAG, sapphire, ALON, and quartz,” in SPIE Defense, Security, and Sensing (International Society for Optics and Photonics, 2011), p. 80160T-1-80160T-10), wide spectral bandwidths, and large acceptance angles (J. J. Cowan, “Aztec surface-relief volume diffractive structure,” JOSA A 7, 1529-1544 (1990)).

The potential for ARSS structures in ZnS has been previously demonstrated using a small spot from a UV laser, rastered across the sample surface, producing a rARSS structure via partial surface re-deposition. See K. J. Major, et al., “Surface transmission enhancement of ZnS via continuous-wave laser microstructuring,” in SPIE Proc. v. 8968, Laser-based Micro- and Nanoprocessing VIII, U. Klotzbach, et al., eds. (2014), p. 896810. While this technique provides a relative increase in transmittance of a ZnS surface of up to 9%, the process is slow due to the need to raster a small spot, and therefore would be costly to apply on a large optic.

### SUMMARY OF THE INVENTION

The invention described herein, including the various aspects and/or embodiments thereof, meets the unmet needs of the art, as well as others, by providing methods for fabricating antireflective surface structures (ARSS) on optical elements. Optical elements having ARSS patterned on at least one surface are also provided.

In one aspect of the invention, a method for fabricating an antireflective surface structure (ARSS) on a II-VI optic includes providing an optical element comprising a II-VI material having an absorption edge; and exposing at least one surface of the optical element to a laser beam having a wavelength from below the absorption edge of the II-VI material to a maximum wavelength within the absorption edge of the II-VI material, wherein ARSS are formed on the at least one surface of the optical element.

In one aspect of the invention, a method for fabricating an antireflective surface structure (ARSS) on a II-VI optic includes providing an optical element comprising a II-VI material; applying a seed layer to at least one surface of the optical element; and dry etching at least one surface of the optical element, wherein ARSS are formed on the at least one surface of the optical element.

In another aspect of the invention, II-VI optical elements are provided. The optical elements include ARSS on at least one surface, wherein individual ARSS features exhibit center-to-center width of adjacent features that varies according to 0.1≤d≤10, where d equals a wavelength for which reduced reflection is desired, divided by twice the refractive index of the material used to form the II-VI optical element, and wherein individual ARSS features exhibit peak-to-peak height of adjacent features that varies according to 0.1≤H≤10, where H equals one-half of the wavelength for which reduced reflection is desired.

Other features and advantages of the present invention will become apparent to those skilled in the art upon examination of the following or upon learning by practice of the invention.

### BRIEF DESCRIPTION OF THE DRAWINGS

FIG. 1 is a schematic diagram of a cross section of an optical surface having random ARSS features across the surface.

FIG. 2 is a diagram of a laser ablation setup.

FIG. 3 is a graph of surface roughness as a function of irradiation energy.

FIG. 4 is a graph of surface roughness as a function of net irradiation energy.

FIG. 5 is a graph of infrared transmission of a single surface of a ZnS sample before and after laser treatment.

FIG. 6 is a photomicrograph of a ZnS surface roughened via RIE etch with Hz.

### DETAILED DESCRIPTION OF EMBODIMENTS OF THE INVENTION

The invention described herein, including the various aspects and/or embodiments thereof, meets the unmet needs of the art, as well as others, by providing methods for fabricating antireflective surface structures (ARSS) on optical elements. Optical elements having ARSS on at least one surface are also provided.

ARSS may be understood conceptually as providing a gradual transition in refractive index from one medium (medium A) to another (medium B). As light passes from A to B, the effective index in a given plane increases from that of A to that of B, as more of the area of a given plane is composed of medium B.

Optical Elements.

Optics or optical elements that are encompassed by the invention include, but are not limited to, windows, lenses, mirrors, end faces of optical fibers (where the fiber may be bare, or connectorized in a commercially-available or custom fiber connector), filters, beamsplitters, prisms, gratings, and diffusers. The optic may be an end cap that is cemented or fusion spliced to the end of an optical fiber. The optic may be a lens at the end of an optical fiber, and may be a standard refractive or graded index (GRIN) lens that is cemented or fusion spliced to the end of the fiber. Alternately the optic may be a lens that is formed directly on the end of the fiber by machining or by thermal processing. In addition to planar optical elements, such as windows, ARSS may be fabricated on non-planar optical elements in which one or both surfaces have a positive or negative curvature, or are cone-shaped, using the methods of the invention. The ARSS described here can be applied to an optical element having any surface configuration, including, for example, surfaces that are flat, curved, or cone-shaped.

The wavelengths being transmitted by the optical elements of the invention, which are used as a point of reference for the period of the pattern and the height of the ARSS structures, include the wavelengths that encompass the visible spectrum (i.e., wavelengths from about 390 nm to about 700 nm), as well as near ultraviolet (i.e., wavelengths from about 300 nm to about 400 nm). In some aspects of the invention, the wavelengths being transmitted make up one of the regions of infrared radiation: near infrared (i.e., wavelengths from about 0.75 μm to about 1.4 μm), short-wavelength infrared (i.e., wavelengths from about 1.4 μm to about 3 μm), mid-wavelength infrared (i.e., wavelengths from about 3 μm to about 8 μm), and long-wavelength infrared (i.e., wavelengths from about 8 μm to about 15 μm).

The wavelengths to be transmitted (and not reflected) are influenced by the materials selected to form the optical elements of the invention. Preferred materials for use in the methods and optical elements of the invention are II-VI semiconductor materials comprising elements from Group IIB of the Periodic Table (now IUPAC Group 12), which includes Zn and Cd, and chalcogens from Group VIB of the Periodic Table (now IUPAC Group 16), which includes S, Se, and Te. These II-VI semiconductor materials include, but are not limited to, ZnS, ZnSe, ZnTe, CdS, CdSe, and CdTe.

The optical elements, regardless of configuration and composition, may be provided with ARSS over all or a portion of their surface, depending on the particular application for the optical element. This may be accomplished using laser irradiation, in which the laser spot size is controlled to cover the entire optic or a portion of the optic. This may also be accomplished by etching the surface of the optic, where either the entire surface is etched, or a portion of the surface is etched and other portions that are not to be etched are covered with a mask. The optical elements may optionally be designed to have ARSS in more than one region, with each region having ARSS configured to reduce reflection of a different wavelength or range of wavelengths.

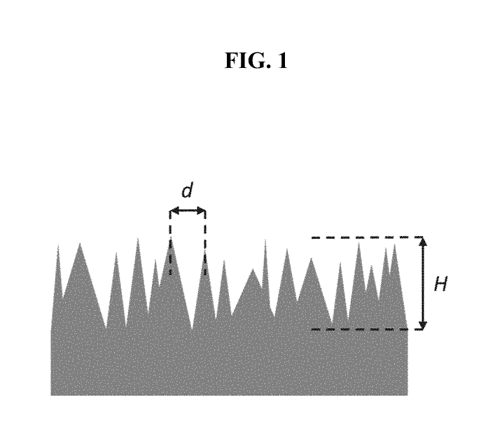

With reference to FIG. 1, the spacing of the ARSS features depends on the refractive index of the optical element, with the center-to-center spacing of adjacent features, d, being approximately less than the wavelength for which reduced reflection is desired, divided by twice the refractive index of the material used to form the optical element. The value of d may not be identical for all sets of adjacent features, and can vary by a factor of from 0.1 to 10 times its nominal value. The height of the ARSS features is preferably selected to be approximately one-half the wavelength for which reduced reflection is desired, or approximately one-half of the smallest wavelength in the range of wavelengths for which reduced reflection is desired. H may be measured as the peak-to-peak height of the features. The value of H may not be identical for all sets of adjacent features, and can vary by a factor of from 0.1 to 10 times its nominal value.

In practice, the ARSS formed by the methods of the invention may include a random array of nanoscale structures in which the width between the ARSS is less than the wavelength of electromagnetic radiation for which reduced reflection is desired. In other embodiments, the ARSS of the invention may be formed in a pattern on an optic, where the period of the ARSS that form the pattern is less than the wavelength of electromagnetic radiation for which reduced reflection is desired. When a range of wavelengths are transmitted through the optic, the width between structures or period of the pattern, respectively, are preferably less than the smallest wavelength in the range of wavelengths for which reduced reflection is desired.

The ARSS may be created in a manner that forms a pattern. This is typically the case, for example, when an ARSS is created photolithographically or stamped. In some aspects of the invention, the pattern is designed to produce ARSS features that are separated by the preferred widths (d) and exhibit the preferred heights (H), as defined above.

Alternately, the ARSS may be random or non-patterned ARSS (rARSS). When the term rARSS is used, it may be used to refer to the fact that the individual ARSS features do not exhibit a repeated pattern. For example, “random” may be used to refer to features that arise from processes having a random component, e.g. ablation rates that vary randomly from point to point on a surface of an optical element. rARSS may be created, for example, via etching, or irradiation and re-deposition processes. It is to be appreciated that when the ARSS features are random or non-patterned, although many or most of the features are preferably separated by the preferred widths (d) and exhibit the preferred heights (H) set forth above, there will also be features that do not conform. Preferably, less than 25% of the rARSS features do not conform to the preferred widths (d) and heights (H), more preferably less than 15%, still more preferably less than 10%, most preferably less than 5%.

In some aspects of the invention, rARSS are preferred. For example, randomness of feature sizes may allow rARSS to provide AR performance over a broader spectral range than ordered ARSS. Random features are distinct from those that arise from patterning with an ordered process, e.g. patterning with a photomask with a repeated, ordered pattern or multi-beam holographic exposure.

The ARSS formed by the methods of the invention, whether provided in a random array or formed as a pattern, preferably provide the optical element with individual features or structures having a height that is less than the wavelength of the electromagnetic radiation for which reduced reflection is desired. The height of the features may be from about 25% to about 100% of the wavelength of the electromagnetic radiation for which reduced reflection is desired. In some particularly preferred embodiments, they have a height that is about one-half of the wavelength for which reduced reflection is desired. This beneficially permits simulation of a graded index variation between the medium surrounding the optical element (which is preferably air, but may vary depending on the application for which the optic is used) and the material forming the optical element.

The invention provides optical elements which exhibit reduced surface reflections at specified wavelengths as compared to untreated optical elements. The term “reduced reflection,” as used in accordance with the invention, refers to a reduction in the amount of reflection of a given wavelength of electromagnetic radiation over the area of the optical element upon which the ARSS or rARSS are formed. The reduction may be a complete reduction, i.e., 100% reduction in reflection. The reduction may also be a partial reduction, i.e., 10%, 20%, 30%, 40%, 50%, 60%, 70%, 80%, 90%. Preferably, the reduction in reflection at a given wavelength or over a range of wavelengths is at least 50%. More preferably the surface reflections are reduced by at least 90%.

The anti-reflective (AR) property of the optical elements having random ARSS formed by the methods of the invention may be optically broadband, with low reflection over a spectral band. The resulting spectral band is greater than that for either antireflective dielectric films or ordered ARSS. In some preferred aspects, the low reflection is provided over a spectral band that is at least about 2 μm wide, preferably at least about 4 μm wide, more preferably at least about 6 μm wide, even more preferably at least about 8 μm wide. Reduced surface reflection also serves to increase the amount of light transmitted through an optic, and prevents back reflections that can be detrimental to the performance of optical systems.

Providing ARSS on the surface of the optics of the invention beneficially yields transmission over a wider field of view and shows less dependence on polarization of the incident light on that surface, as compared to traditional antireflective coatings. The invention may also beneficially provide a significantly higher laser-induced damage threshold (LIDT) for the optical elements of the invention, in comparison to untreated optics, as well as dielectric antireflective-coated optics.

Laser Irradiation.

Laser irradiation may be used to form ARSS or rARSS features over an area that is at least about 0.1 mm, preferably at least 1 mm. In some embodiments of the invention, the area over which ARSS or rARSS are formed is preferably greater than 4 mm in diameter. In some embodiments, the entire optic or a substantial portion of the optic may be treated at once. The laser spot size can be increased, limited only by the available laser power, to expose areas up to about 5 cm in diameter, and may be even larger. Where the laser spot size is not sufficiently large to cover the entire optical element, the surface of the optical element may be exposed in multiple spatially separated steps in order to treat a surface larger than the laser spot size. Exposures may be overlapped to prevent gaps between treated areas.

In one embodiment of the invention, restructuring the surface of a II-VI material, such as ZnS, may be carried out using low-energy laser irradiation of the material, and localized re-deposition. For example, ZnS absorbs light for wavelengths shorter than 355 nm. Near 355 nm, the absorption is high enough (>0.95) to disturb the surface and cause localized (minor) ablation. This leads to a light-induced localized sputtering of the material, which is then redeposited. The resulting surface is randomly roughened.

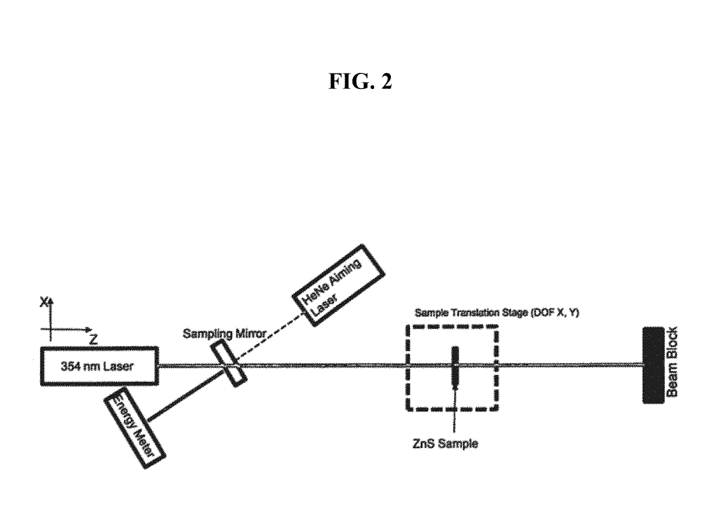

FIG. 2 shows an exemplary laser ablation setup. The setup includes: a UV laser, emitting at a wavelength of 354 nm; a sampling mirror which picks off part of the beam in order to measure energy in real time; a HeNe aiming laser for alignment; a sample (i.e., an optic to be treated); a sample translation stage to position the sample; and a beam block to collect unabsorbed light.

In one presently-preferred embodiment, where ZnS is the II-VI material of the optic, a tripled-frequency Nd:YAG operated at 354 nm wavelength may be used as the irradiating laser. The laser energy may be controlled through Q-switching. The beam can be focused or defocused to control the irradiation intensity. The irradiating beam profile is Gaussian, with a 4.5 mm diameter spot at the sample surface location.

The optical element may be exposed in multiple locations, potentially with different Q-switch times and numbers of pulses, and these exposed spots can be measured separately. The exposed area may be exposed with between one and ten pulses, each with an energy between 10 and 5,000 mJ/cm². Preferably, each pulse has an energy between 200 and 600 mJ/cm². The pulse width may be between 6 and 8 nanoseconds. The number of pulses, pulse energy, and pulse duration may be controlled to provide ARSS features having peak-to-peak spacing and heights that are selected to result in reduced reflection of a selected wavelength or range of wavelengths.

A laser operating at a wavelength other than 354 nm may be used in accordance with the invention. For example, when fabricating ARSS or rARSS on a ZnS surface, any laser having a wavelength less than approximately 600 nm will have some absorption in the ZnS, and can therefore be used to structure its surface. For other II-VI materials, any laser operating at a wavelength below or within the absorption edge of the material may be used to structure the surface of the material. For example, the 488 nm or 514 nm line of an argon ion laser may be used to structure CdSe or CdTe. The “absorption edge” of a material is defined as the broad region in the optical spectrum where the optical transmittance decreases from a large value at longer wavelengths to a lower value at shorter wavelengths. Any laser operating at a wavelength from below the absorption edge to the maximum wavelength within the absorption edge may be used in accordance with the invention. Those skilled in the art are able to determine appropriate wavelengths and energies to be used in carrying out the laser patterning embodiment of the invention on optical elements formed from other II-VI materials, such as ZnSe, ZnTe, and CdS. In ZnSe, for example, a wavelength below approximately 800 nm may be used; in ZnTe a wavelength below approximately 900 nm may be used; in CdS a wavelength below approximately 600 nm may be used; in CdSe a wavelength below approximately 600 nm may be used; and in CdTe a wavelength below approximately 1000 nm may be used.

Optimization of the irradiation process may be carried out in order to significantly reduce reflection loss and further improve transmission of the optical element having ARSS. Optimization may include variation of Q switch times; number of pulses irradiating each location; beam focus; beam power, controlled by beam focus, laser current, application of an optical filter, or any other mechanism; amount of spatial overlap between exposed regions, and translation speed between exposed regions. Optimization may also include the environment during exposure, where a gas, including one or more inert gases, such as nitrogen or argon, or one or more reactive gases, such as oxygen or hydrogen sulfide, can be present. Optimization may also include pressure during exposure, where a pressure between high vacuum of approximately 10⁻⁷ T and several times atmospheric pressure, approximately 10⁴ T, may be used.

Etching.

In accordance with another aspect of the invention, etching processes may be used to produce ARSS structures on II-VI optical elements. Preferably, a dry etch process is used. The dry etch processes that may be used in accordance with the invention encompass any technique in which the material being etched is bombarded with ions (which may be provided as a plasma of reactive gases) that dislodge portions of the material from the surface. These may include high density plasma (HDP) etching, inductively coupled plasma reactive ion etching (ICP-RIE), and reactive ion etching (ME). A preferred dry etch technique for use in carrying out the methods is ME.

The optical element to be etched may optionally be coated with a seed layer prior to etching to aid in the initial formation of surface structures. When provided, this layer may have a thickness between 10 nm and 200 nm. The seed layer may be deposited onto the optic using standard methods for deposition, including methods such as sputtering or evaporation. As an example, the seed layer may include a metal such as gold, aluminum, silver, chromium, and alloys thereof incorporating any of these metals. The metals and alloys may optionally include one or more dopants, such as chromium, titanium, iron, or aluminum. The seed layer is preferably less than 100 nm thick, and in some aspects of the invention, the seed layer is estimated to be about 10 to 25 nm in thickness. The seed layer may be deposited such that less than a complete layer of the seed material is formed on the optic.

When optical elements are etched in a RIE vacuum chamber, the pressure in the chamber is preferably maintained between 5 mTorr and 100 mTorr. The reactive gas is selected from fluorocarbons, oxygen, chlorine, boron trichloride, hydrogen, sulfur hexafluoride, and combinations thereof, and is selected based on the material being etched. The reactive gas may be supplied along with a diluent gas, such as nitrogen, argon, helium, krypton, xenon and combinations thereof. The gas or gases may be delivered at a flow rate of from 2 sccm to 200 sccm. Optimization of the etching process may be carried out in order to achieve the desired ARSS feature dimensions, which may be selected to significantly reduce reflection loss and further improve transmission of the optical element having ARSS.

### EXAMPLES

The invention will now be particularly described by way of example. However, it will be apparent to one skilled in the art that the specific details are not required in order to practice the invention. The following descriptions of specific embodiments of the present invention are presented for purposes of illustration and description. They are not intended to be exhaustive of or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated.

### Example 1

The setup illustrated in FIG. 2 was used to roughen a ZnS sample surface (Cleartran Dow Corning Corporation, Midland, Mich.).

A tripled-frequency Nd:YAG operated at 354 nm wavelength was used as the irradiating laser. The laser energy was controlled through Q-switching. The beam can be focused or defocused to control the irradiation intensity. The irradiating beam profile was Gaussian, with a 4.5 mm diameter spot at the sample surface location.

The sample surface was exposed in multiple locations, with different Q-switch times and different numbers of pulses. The exposed area was exposed with between one and ten pulses, each with an energy between 10 and 5,000 mJ/cm². Optimally, each pulse has an energy between 200 and 600 mJ/cm². The pulse width may be between 6 and 8 nanoseconds.

All exposed areas were tested with energy dispersive spectroscopy to verify the absence of ZnO formation on the surface after ablation, and it was confirmed that ZnO did not form.

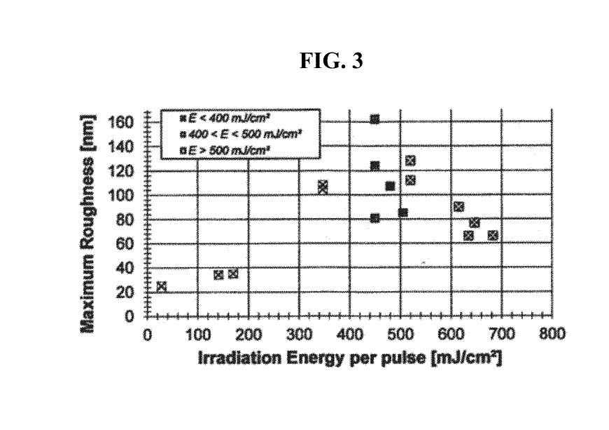

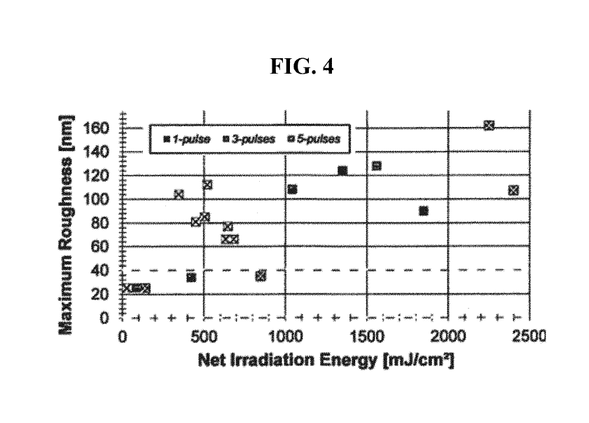

It was found that the surface was roughened as a result of laser exposure. As shown in FIG. 3, the maximum roughness measurement shows that there is an energy/pulse threshold (˜200 mJ/cm²), above which the roughness increases by approximately a factor of four. When exposing the sample with multiple pulses, it was found that, above the energy/pulse threshold (˜200 mJ/cm²), the maximum roughness also increases with the net irradiation (i.e., the number of pulses). These results are shown in FIG. 4.

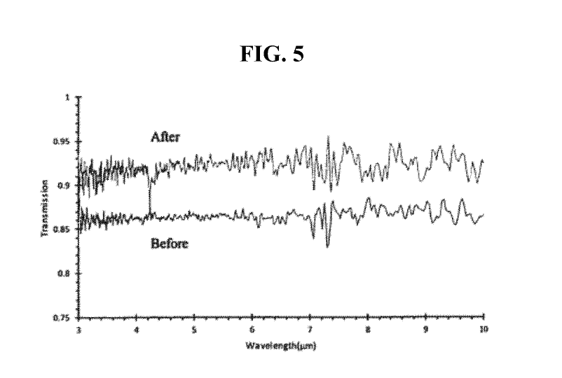

This structure results in an increase in transmittance of the sample. FIG. 5 shows a plot of the transmittance through a ZnS Cleartran sample treated on one side. After the laser etch treatment, the transmittance is increased by approximately 5-6% for a single surface across the 3-10 μm wavelength range (corresponding to a reduction in reflectance over a 7 μm spectral band). This compares to a maximum theoretical increase of 14.5% per surface.

### Example 2

ZnS windows were etched in a reactive ion etch (RIE) chamber in the presence of H₂ gas. The sample was first coated with a layer of gold having a thickness between 10 nm and 200 nm. This layer aided in the initial formation of surface features. The sample was placed into an ME chamber, and a mixture of H₂ gas and He gases were flowed in the chamber. He gas was added to improve the stability of the process. The following process parameters were used: pressure=20 mTorr; total flow rate=10 sccm; ratio of gases=7 parts H₂/3 parts He; etch time=15 min.

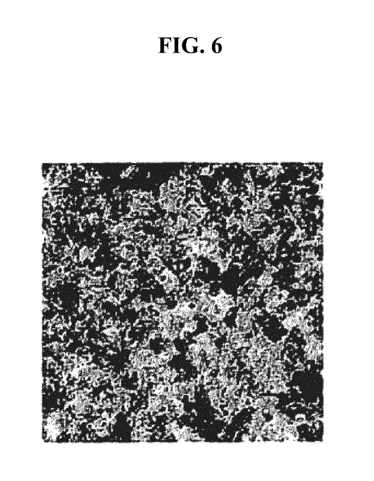

This etch procedure etched the ZnS surface to a depth of 3.159 μm, at an etch rate of approximately 200 nm/min, and produced a roughened surface. FIG. 6 shows an image of a ZnS surface roughened via this procedure.

It will, of course, be appreciated that the above description has been given by way of example only and that modifications in detail may be made within the scope of the present invention.

Throughout this application, various patents and publications have been cited. The disclosures of these patents and publications in their entireties are hereby incorporated by reference into this application, in order to more fully describe the state of the art to which this invention pertains.

The invention is capable of modification, alteration, and equivalents in form and function, as will occur to those ordinarily skilled in the pertinent arts having the benefit of this disclosure. While the present invention has been described with respect to what are presently considered the preferred embodiments, the invention is not so limited. To the contrary, the invention is intended to cover various modifications and equivalent arrangements included within the spirit and scope of the description provided above.

What is claimed:

1. A method for fabricating antireflective surface structures (ARSS) on an optic, comprising:
providing an optical element comprising a II-VI material having an absorption edge; and
exposing at least one surface of the optical element to pulses from a laser beam having a wavelength from below the absorption edge of the II-VI material to a maximum wavelength within the absorption edge of the II-VI material,
wherein ARSS are formed on the at least one surface of the optical element.

2. The method of claim 1, wherein the optical element is selected from the group consisting of windows, lenses, mirrors, end faces of optical fibers, filters, beamsplitters, prisms, gratings, and diffusers.

3. The method of claim 1, wherein the optical element is formed from a material selected from the group consisting of ZnS, ZnSe, ZnTe, CdS, CdSe, and CdTe.

4. The method of claim 1, wherein the ARSS are formed as a pattern.

5. The method of claim 1, wherein the ARSS are formed as a random array.

6. The method of claim 1, wherein the at least one surface of the optical element is exposed to between one and ten pulses of the laser beam.

7. The method of claim 1, wherein each pulse of the laser beam has an energy between 200 and 600 mJ/cm².

8. The method of claim 1, wherein each pulse has a width of between 6 and 8 nanoseconds.

9. The method of claim 1, wherein the at least one surface of the optical element is exposed to the laser beam in an environment comprising inert gases selected from the group consisting of nitrogen, and argon.

10. The method of claim 1, wherein the at least one surface of the optical element is exposed to the laser beam in an environment comprising reactive gases selected from the group consisting of oxygen, and hydrogen sulfide.

11. The method of claim 1, wherein the at least one surface of the optical element is exposed to the laser beam at a pressure of from approximately 10⁻⁷ T to approximately 10⁴ T.

12. A II-VI optical element comprising ARSS on at least one surface,
wherein individual ARSS features exhibit center-to-center width of adjacent features that varies according to 0.1≤d≤10, where d equals a wavelength for which reduced reflection is desired, divided by twice the refractive index of the material used to form the II-VI optical element, and
wherein individual ARSS features exhibit peak-to-peak height of adjacent features that varies according to 0.1≤H≤10, where H equals one-half of the wavelength for which reduced reflection is desired.

13. The II-VI optical element of claim 12, where the center-to-center width is less than the wavelength for which reduced reflection is desired.

14. The II-VI optical element of claim 12, where the peak-to-peak height of the features is from about 25% to about 100% of the wavelength for which reduced reflection is desired.

15. The II-VI optical element of claim 12, where the optical element is formed by the method of claim 1.
